(19) United States
(12) Patent Application Publication
(10) Pub. No.: US 2004/0099481 A1
(43) Pub. Date: May 27, 2004

(54) Fluid sump drainage

(76) Inventor: Scott Mitchell, Church Stretton (GB)

Correspondence Address: CATERPILLAR INC., 100 N.E. ADAMS STREET, PATENT DEPT., PEORIA, IL, 616296490

(21) Appl. No.: 10/303,682

(22) Filed: Nov. 25, 2002

(51) Int. Cl. F16C 3/14

(52) U.S. Cl. 184/1.5

(57) ABSTRACT

This invention relates to a sump for an internal combustion engine and a method for draining a sump. In prior sumps, a drain aperture was commonly provided in the floor of the sump to provide good draining characteristics. Where a drain aperture in the sump floor was not practical, a side wall drain aperture was used, but with less than desirable draining characteristics because the drain aperture was above the sump floor for structural reasons. In accordance with this invention, the sump floor has at least one gutter. A closable drain aperture is located such that at least its lowermost part is located within the gutter. When the drain aperture is opened, oil within the sump can flow along the gutter and through the aperture. The gutter may form a support rail to support the weight of an engine.

### TECHNICAL FIELD

This invention relates to the draining of sumps in which fluid is collected, and is particularly but not exclusively applicable to the draining under gravity of oil sumps for internal combustion engines through a closable drain aperture provided in the sump.

### BACKGROUND

In the majority of internal combustion engines, lubricating oil drains into a sump from which the oil is drawn to be pumped around the lubrication circuit. The sump is conventionally a generally rectangular pan and is provided with a drain aperture closed by a drain plug.

The drain plug is commonly located on the bottom surface of the sump. However there are applications, such as some generator sets and some marine uses, where access to the underside of the sump is restricted or impossible.

It is known to position the drain plug in the lower region of a side wall of the sump. Because of the need to provide sufficient space to accommodate a screw thread for the drain plug and a landing for a drain plug washer, the actual drainage aperture of a side-located drain plug is some distinct height above the floor of the sump, and thus opening of the drain plug will achieve incomplete removal of the oil. Moreover, the retained contents will include any sludge or contamination present and it will be difficult to flush this out.

The present invention seeks to provide a sump, and a method of draining a sump, which overcome these problems.

### SUMMARY OF THE INVENTION

The present invention provides a sump for an internal combustion engine comprising a box having a peripheral wall and a floor.

The floor is formed with at least one gutter adjacent a portion of the peripheral wall.

A closable drain aperture is located in the peripheral wall with at least the lowermost part of the drain aperture located within said at least one gutter.

From another aspect, the invention provides a method for draining fluid from a sump having a floor and at least one closable drain aperture, the method comprising the steps of:

opening the at least one drain aperture; and

causing fluid to flow within the sump along at least one gutter formed in the floor of the sump and through the at least one drain aperture.

### BRIEF DESCRIPTION OF THE DRAWINGS

FIG. 1 is a side view of a sump for an internal combustion engine, forming one embodiment of the present invention; and

FIG. 2 is a cross-section, to an enlarged scale, taken on the line 2-2 of FIG. 1.

### DETAILED DESCRIPTION

Referring to the drawings, one embodiment of the present invention is now described, by way of example only.

A sump, generally designated 10, has the general form of an open-topped, rectangular box with a peripheral wall 11 formed by side walls 12, 14, end walls 16, 18 and a floor 20. A top flange 22 provides locations for fasteners 24 by which the sump is secured beneath the crankcase of an engine 50. It is to be understood that the sump 10 may also take the form of a closed box, such as an engine casing. The box may be a shape other than rectangular. The peripheral wall 11 may be vertical or sloping and may include other arrangements of side walls and end walls.

On each of the side walls 12, 14 the sump 10 is provided with a drain aperture 28 which is shown closed by a removable drain plug 26 and with an access opening 46 for an optional oil heater circuit which is shown closed by a blanking plug 44. The access opening 46 does not form part of the present invention, and may be omitted.

The floor 20 is formed with a gutter 30 adjacent a portion of the peripheral wall, in this embodiment with a gutter 30 on either side adjacent the corresponding side wall 12, 14 and extending along the length of the sump 10.

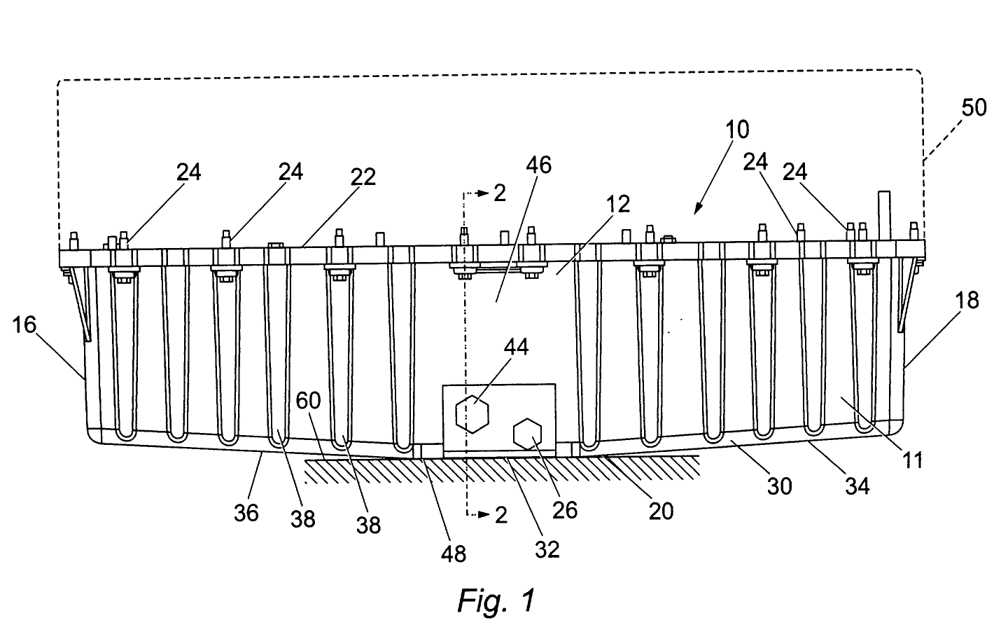

The floor 20 is also formed (see FIG. 1) to have a flat lowermost portion 32 in the vicinity of the drain plugs 26 which is horizontal in use. On either side of the lowermost portion 32 are sloping portions 34, 36 of the floor which slope towards the lowermost portion 32. In the illustrated embodiment the lowermost portion 32 is arranged at the centre of the sump 10, but it is to be understood that it may be arranged at an off-centre position or adjacent to an end wall 16, 18 of the sump, in which case only one sloping portion 34, 36 of the floor is provided.

The gutters 30 in this embodiment have a cross-sectional shape which is shallow and approximately rectangular, but other shapes could be used, such as part-circular, trapezoidal or triangular.

The drain plugs 26 are removably secured in drain apertures 28 formed by threaded inserts 42. Each drain aperture 28 is positioned to have at least its lowermost part 29 within the respective gutter 30.

The sump 10 of this embodiment is moulded from reinforced plastics. Alternative materials may be used, such as cast iron or pressed sheet steel or aluminium alloy. The side walls 12, 14 and end walls 16, 18 are formed with stiffening ribs 38. The gutters 30 assist in stiffening the floor 20, and form support rails 48 adapted for resting on a support surface 60 to carry the weight of an engine 50 to which the sump 10 is attached.

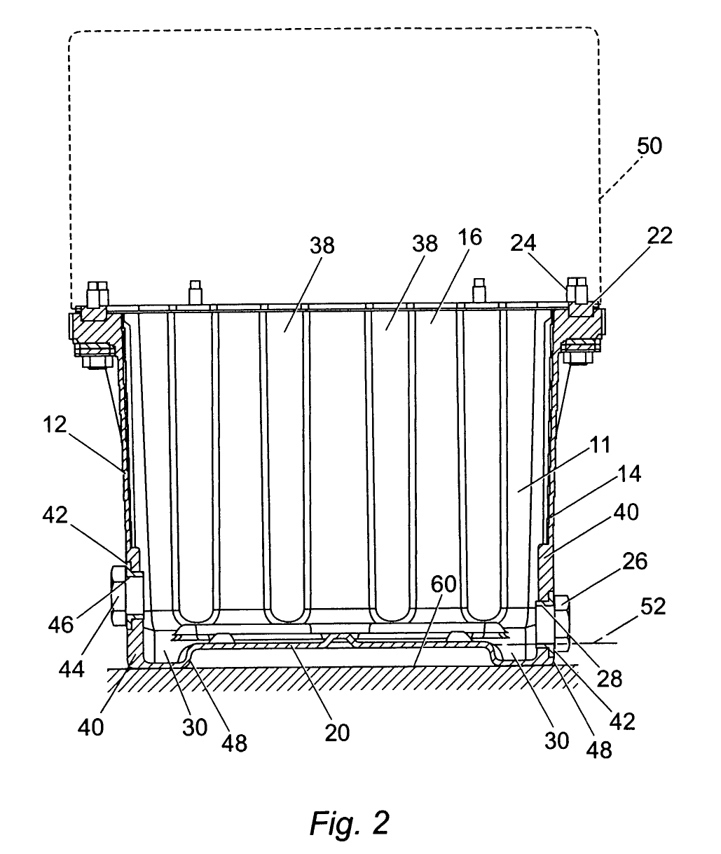

As seen in FIG. 2, the thickness of the side walls 12, 14 is increased to form thickened lower portions 40 in the side walls 12, 14 adjacent to the lowermost portion 32 of the floor. The thickened portions 40 of the side walls 12, 14 are occupied by the drain apertures 28 and access openings 46.

The drain plugs 26 and blanking plugs 44 are conventionally threaded plugs which screw into the threaded metal inserts 42 which are secured in the thickened wall portions 40.

Modifications to the foregoing embodiment may be made within the scope of the invention. For example,

the sump 10 may have a gutter 30 on one side only, a single drain aperture 28 may be provided, the drain aperture or apertures 28 need not be longitudinally central, and the sloping portions of the floor could be dispensed with so that in use the floor 20 is horizontal and the gutter 30 is sloping or horizontal. One or more transverse gutters may connect the longitudinal gutters 30. The gutter adjacent a portion of the peripheral wall 11 may be a transverse gutter extending across the floor 20 of the sump at an intermediate location, with the drain aperture 28 provided at the end of the transverse gutter.

### Industrial Applicability

When it is desired to drain oil from the sump 10, one of the drain plugs 26 is removed, thereby opening the drain aperture 28. The oil in the sump is then free to flow out of the sump 10 through the drain aperture 28. As the oil flows through the drain aperture 28, the level of the oil in the sump falls. Because the gutters 30 are formed to be below the adjacent floor 20, as the oil level falls oil will tend to flow from the floor 20 into the gutter or gutters 30. Oil then flows along the gutter or gutters 30 and then through the drain aperture 28 until the oil level reaches the level of the lowermost part 29 of the drain aperture 28, this level being indicated at 52 in FIG. 2. At this point the sump 10 will contain only the small quantity of oil which remains below level 44 in the gutter or gutters 30 in the lowermost portion 32 of the floor. The area of the floor 20 between the gutters 30 will be free of oil.

It is to be understood that the sloping portions 34, 36 in the floor 20 may be omitted. In this case after draining the sump 10 will contain only the small quantity of oil which remains below level 44 along the complete length of the gutter. Since the cross sectional area of the gutter is small compared to the cross sectional area of the sump, this remaining quantity of oil is small compared to the quantity of oil in the sump before draining. Again, the area of the floor 20 between the gutters 30 will be free of oil.

The thickened portions 40 in the side walls 12, 14 increase the strength of the side walls 12, 14 in the area of the lowermost portion 32 of the floor 20. This allows the gutters 30 in the lowermost portion 32 to be used as support rails 48 to support the weight of an entire engine 50 when they rest temporarily on a supporting surface 60, without risk of damage to the side walls 12, 14 due to local buckling or other structural failure.

The present invention provides an improved sump which may be used with all kinds of internal combustion engines, or with any other mechanical apparatus in which fluid is circulated or stored and from which the fluid must be periodically drained, such as cooling or hydraulic fluid reservoirs. The improved sump allows good oil drainage in situations where access to the underside of the engine is not possible or not practical, with limited residual oil left in the sump. Cleaning of the sump is also facilitated.

What is claimed is:

1. A sump for an internal combustion engine, comprising:
a box having a peripheral wall and a floor;
at least one gutter formed in the floor adjacent a portion of the peripheral wall; and
a first closable drain aperture located in the peripheral wall with at least the lowermost part of the drain aperture located within said at least one gutter.

2. A sump according to claim 1, including a drain plug removably provided within the first drain aperture.

3. A sump according to claim 1, wherein the peripheral wall includes first and second side walls and the floor is formed with first and second gutters adjacent the first and second side walls respectively.

4. A sump according to claim 2, wherein the peripheral wall includes first and second side walls and the floor is formed with first and second gutters adjacent the first and second side walls respectively.

5. A sump according to claim 3, wherein the first drain aperture is located within the first side wall and a second closable drain aperture is located in the second side wall with at least the lowermost part of the second drain aperture located within said second gutter.

6. A sump according to claim 3, wherein the first drain aperture is located within the first side wall and a second closable drain aperture is located in the second side wall with at least the lowermost part of the second drain aperture located within said second gutter.

7. A sump according to claim 3, wherein the gutters form support rails adapted for resting on a support surface.

8. A sump according to claim 4, wherein the gutters form support rails adapted for resting on a support surface.

9. A sump according to claim 1, wherein the floor and gutters slope towards the location of the drain aperture.

10. A sump according to claim 3, wherein the floor and gutters slope towards the location of the drain aperture.

11. A sump according to claim 7, wherein the floor and gutters slope towards the location of the drain aperture.

12. A sump according to claim 3, wherein the floor has a lowermost portion in which the floor and gutters are horizontal in use; wherein the floor has at least one sloping portion adjacent the lowermost portion of the floor in which the floor and gutters drain towards the lowermost portion in use; and wherein each drain aperture is located in a lower portion of the respective side wall adjacent the lowermost portion of the floor.

13. A sump according to claim 7, wherein the floor has a lowermost portion in which the floor and gutters are horizontal in use; wherein the floor has at least one sloping portion adjacent the lowermost portion of the floor in which the floor and gutters drain towards the lowermost portion in use; and wherein each drain aperture is located in a lower portion of the respective side wall adjacent the lowermost portion of the floor.

14. A sump according to claim 12, wherein the side walls have an increased wall thickness locally in the area of the lower portions of the side walls.

15. A method for draining fluid from a sump having a floor and at least one closable drain aperture, the method comprising the steps of:
opening the at least one drain aperture formed in a peripheral wall of the sump; and
causing fluid to flow within the sump along at least one gutter formed in the floor of the sump adjacent to a portion of the peripheral wall and through the at least one drain aperture.

16. A method according to claim 15, wherein the fluid flow step includes causing fluid to flow through at least a lowermost part of the at least one drain aperture, said lowermost part being located within said at least one gutter.

17. A method according to claim 15, wherein said peripheral wall includes first and second side walls and said sump includes first and second closable drain apertures formed in the first and second side walls respectively, and wherein the fluid flow step includes causing fluid to flow within the sump along first and second gutters located adjacent to the first and second side walls respectively.

18. A method according to claim 16, wherein said peripheral wall includes first and second side walls and said sump includes first and second closable drain apertures formed in the first and second side walls respectively, and wherein the fluid flow step includes causing fluid to flow within the sump along first and second gutters located adjacent to the first and second side walls respectively.

19. A method according to claim 15, wherein the sump floor has a lowermost portion in which the floor and the at least one gutter are horizontal and at least one sloping portion adjacent the lowermost portion of the floor in which the floor and the at least one gutter drain towards the lowermost portion, and wherein the fluid flow step includes causing fluid to flow within the sump along the at least one gutter to the lowermost portion of the floor and then through the drain aperture.
